(19) United States
(12) Patent Application Publication
(10) Pub. No.: US 2018/0267731 A1
(43) Pub. Date: Sep. 20, 2018

(54) Method for Operating a Sensor and Method and Device for Analyzing Data of a Sensor

(71) Applicant: Robert Bosch GmbH, Stuttgart (DE)

(72) Inventor: Nikolaos Gortsas, Sindelfingen (DE)

(21) Appl. No.: 15/918,745

(22) Filed: Mar. 12, 2018

(30) Foreign Application Priority Data
Mar. 16, 2017 (DE) 10 2017 204 400.4

(51) Int. Cl. G06F 3/06; G01D 18/00

(52) U.S. Cl. CPC G06F 3/0635; G06F 3/0619; G01D 18/00; G06F 3/0685; G06F 3/0659

(57) ABSTRACT

A method for operating a sensor includes continuously storing a first data of the sensor. The method further includes detecting of a fault of the sensor and permanently storing the first data of the sensor continuously stored before the detection of the fault. The method also includes recording and permanently storing a second data of the sensor after the detection of the fault.

This application claims priority under 35 U.S.C. § 119 to patent application no. DE 102017204400.4 filed on Mar. 16, 2017 in Germany, the disclosure of which is incorporated herein by reference in its entirety.

The disclosure relates to a method for operating a sensor as well as a method and a device for analyzing data of a sensor, wherein data of the sensor are recorded before and after detection of a fault of the sensor.

### BACKGROUND

Sensors are used in a plurality of applications and devices to determine states of the application or device or the environment. On the basis of the determined state information, the application or device can be controlled or regulated and different situations, such as dangerous situations, can be detected. A plurality of sensors are used in particular in the automotive field. In addition to position and acceleration sensors, brightness and moisture sensors and a plurality of other sensor types are also used to design motor vehicles for both added comfort and safety. In particular in the case of sensors that determine safety-relevant information, the detection of faulty sensors is of the utmost importance. Thus, with this type of sensor a significant hazard can be caused if such a sensor is faulty and therefore supplies incorrect data, leading to critical interventions in the operation of the vehicle.

From the prior art, various methods and devices are known that are able to detect a fault of a sensor. These methods can rely on either just a single item of incorrect data or on a plurality of sensor data from a sensor. Based on this information, however, faulty sensors cannot be identified with absolute certainty and do not allow a detailed analysis of the circumstances that may have led to the failure of the sensor.

### SUMMARY

Here, a method and a device in accordance with the disclosure are presented. Advantageous embodiments of the method and device form the subject matter of the dependent claims.

A method for operating on data of a sensor comprises the following steps:

a) Continuous storage of data from the sensor.

b) Detection of a fault in the sensor.

c) Permanent storage of the data that were continuously stored before detection of the fault in the sensor.

d) Recording and permanent storage of data of the sensor after the detection of the fault in the sensor.

In a method for analyzing data of a sensor with a device, at least the following steps are also performed:

e) Evaluation of the permanently stored data of the sensor.

f) Derivation of causes of the fault from the evaluated data from the sensor.

The data from the sensor, such as measurement values, are continuously stored during the operation of the sensor for a predetermined period of time. The sensor can be a position sensor or an accelerometer or an illumination sensor or a moisture sensor or the like. At the same time as the continuous storage of the data from the sensor, it is continuously monitored whether a fault is present in the sensor. If, for example, data from the sensor deviate significantly from normal data of the sensor during a predefined period, then a fault in the sensor is assumed to exist. In doing so, for example, upper and lower limit values for the different types of sensors and data are specified, thus restricting the range of the normal data. Accordingly, if data from the sensor differs from the range defined by the limits of this sensor during the defined period, a fault in the sensor is detected. As soon as a fault in the sensor has been detected, the continuously stored data of the sensor up to that time are then stored permanently. The additional data of the sensor, which the sensor generates after the detection of the fault in the sensor, are also recorded and permanently stored. The recording comprises either the direct storing of the data in a non-volatile memory, or a prior buffering in a volatile memory and a subsequent relocation into the non-volatile memory. Subsequently, the permanently stored data of the sensor are evaluated. Both the data from the sensor which were permanently stored before the detection of the fault in the sensor, and the data from the sensor which were permanently stored after detection of the fault in the sensor, offer a broad basis for deriving the cause of the fault. Based on the evaluated permanently stored data of the sensor, conclusions can be derived as to the origin of the fault.

Thus, the causes of a fault in the sensor can be derived with particularly high confidence. This means that appropriate countermeasures can be taken based on the causes ascertained.

According to a further embodiment, the data of the sensor obtained in step a) are cyclically stored. In this process, the oldest data from the sensor are overwritten with the most recent data from the sensor. The terms “oldest data” and “most recent data” here refer to a subset of data that the sensor produces during a certain time segment, wherein this time segment is normally significantly shorter than the pre-defined time period for which the data are stored. Due to the cyclic storage of the data from the sensor, a predetermined number of data items are continuously stored. In this process the oldest data item from the sensor is continuously overwritten by the most recent data item from the sensor. As soon as a fault in the sensor is detected in step b), the currently stored data of the sensor are stored permanently. Subsequently, the data from the sensor after detection of the fault in the sensor are also recorded and permanently stored. Therefore, no more than the predetermined number of data items from the sensor are located in the memory, which continuously and cyclically stores the data from the sensor.

The cyclic storage of the data from the sensor thus enables an overflow of the memory to be avoided.

According to a further embodiment, in step a) the data from the sensor are stored in a volatile memory until the detection of the fault in step b). In addition, in step c), the data from the sensor are relocated from the volatile memory into a non-volatile memory after detection of the fault in step b).

The volatile memory is preferably an integral component of the sensor or sensor arrangement. The non-volatile memory may, if appropriate, also be an integral component of the sensor or sensor arrangement. It is preferred, however, that the non-volatile memory is a component of a device for analyzing the data, which can be, for example a control unit. It is also possible that the volatile memory is already an integral component of the device for analyzing the data.

In a further embodiment following the detection of a fault in the sensor, the sensor data are marked as invalid in a system for processing the sensor data, so that all applications of the system, which are intended for processing the sensor data, do not process the data that have been detected as faulty. The storage of the data can be carried out immediately after the detection of the fault or after a predefined delay. This can be used to ensure that transient faults have expired before sensor data are stored again.

The volatile memory can be a directly accessed memory (Random Access Memory, RAM). Data that are stored in the volatile memory are only stored for as long as the volatile memory is supplied with power. The non-volatile memory can be a secondary storage medium, such as a hard disk, a compact disc (CD), a digital versatile disc (Digital Virtual Disc, DVD) a floppy disk or a semiconductor memory component (e.g. A Flash memory, Erasable Programmable Read-Only Memory (EPROM) or the like). Data that are stored on the non-volatile memory, are preferably retained in the memory in the event of a disconnection of the power source.

As volatile memories can work at high speed, data streams with a particularly high data transfer rate can also be continuously stored. By the relocation to the presumably slower non-volatile memory, the data from the sensor are stored permanently, including after being disconnected from a power supply.

According to a further embodiment, in step c) m data items of the sensor are permanently stored, or in step d) n data items from the sensor are permanently stored.

The number of stored data items from the sensor before or after the detection of the fault can be limited to m or n. The value of m can be less than, equal to, or greater than n. The value of m and/or n is chosen large enough, so that there is sufficient information available to derive the causes of the fault in the sensor.

Due to the selective specification of the number of data items to be stored and the sampling rate of the sensor, on the one hand, it is ensured not only that sufficient information is available to derive the causes for the fault in the sensor, but also that an unnecessary amount of data is stored. This allows the size and costs of the volatile memory and non-volatile memory to be reduced.

In a further advantageous design, at least one mathematical operation can be applied to the data from a sensor that are identified as faulty. This allows the known mathematical operations to be used to detect specific fault patterns in the sensor data. Such mathematical operations can involve the application of a filter or the determination of a mean value.

According to a further embodiment, data from at least two sensors are acquired in the manner described above, wherein a fault has been detected for at least one of the two sensors. In this case, the method comprises the additional steps:

g. analysis of temporal patterns of the permanently stored data from the at least two sensors.

h. derivation of causes of the fault in the at least one sensor for which a fault was detected in step b).

By permanently storing data from at least two sensors before and after the detection of a fault in one of the at least two sensors, an analysis of the temporal characteristics of the permanently stored data of the at least two sensors can be performed before detection of the fault (step c)) and after detection of the fault (step d)). By means of this analysis the cause of the fault in the at least one sensor can be derived. If, for example, from the time of the detection of the fault only anomalous data (for example, outside of a range specified by limits, or a sudden jump in otherwise constant value over time) exist for the sensor that has been detected as faulty, but not for the remaining sensors, then it can be assumed with a high degree of confidence that there is indeed a fault in this one sensor. If, on the other hand, anomalous data exist for a plurality of sensors from the time of detection of the fault in a sensor, and after a certain period of time following the occurrence of the fault in this sensor all data then normalize, it can then be assumed that interference due to environmental influences (e.g. strong magnetic field, vibration, or the like) was responsible for the anomalous data, and thus no fault in the sensor is present. This is because the likelihood that a plurality of sensors at the same time suffer a fault is extremely low, so that a temporary influence from the environment can be assumed. In this case, the sensor or the system can be reset to a defined initial state. A replacement of the sensor is not necessary in this case. The method can be advantageously extended to any number of sensors.

Therefore, using the method described here the actual presence of a fault in a sensor can be derived with particularly high confidence, and therefore appropriate counter-measures can be taken or the detected fault discarded and a normal operation of all sensors can be resumed.

Also described here is a device for analyzing data from a sensor, in particular in accordance with one of the previously described methods, comprising:
a controller;
a sensor, which is or can be connected to the controller;
a volatile memory, which is or can be connected to the controller and the sensor and which is configured for continuously storing data from the sensor;
a monitoring unit, which is or can be connected to the controller and the sensor or to the volatile memory, and which is configured for detecting faults in the sensor; and
a permanent memory, which is or can be connected to the controller and the volatile memory, and which is configured for permanently storing data from the volatile memory;

The controller is configured, upon detection of a fault in the sensor by the monitoring unit, to permanently store the data of the sensor from the volatile memory before the detection of the fault in the non-volatile memory and to record data of the sensor after the detection of the fault and permanently store said data in the non-volatile memory. In addition, the controller is configured to subsequently evaluate the permanently stored data from the sensor and to derive causes for the fault from the evaluated data from the sensor.

The data from the sensor, which it transmits to the controller, are continuously stored in the volatile memory and continuously monitored by the monitoring unit. As soon as the monitoring unit detects a fault of the sensor on the basis of its data, the controller initiates a relocation of the previously stored data of the sensor from the volatile memory into the non-volatile memory. Thereupon, the additional data of the sensor after the detection of the fault are recorded and permanently stored in the non-volatile memory. The permanently stored data of the sensor before and after the detection of the fault in the sensor are evaluated by the controller and then causes for the fault are derived.

By the analysis of a plurality of stored data before and after detection of the fault in the sensor, a plurality of information is available that allow a particularly accurate evaluation of the causes of the fault in the sensor. Thus, the fault in a sensor and its causes can be determined with particularly high confidence.

According to a further embodiment, the volatile memory is a first-in, first-out (FIFO) memory or a ring buffer.

By the use of a FIFO memory or of a ring buffer, a specific number of data items can be continuously and cyclically stored. In this process, the oldest data item from the sensor is continuously overwritten by the most recent data item from the sensor.

This reduces the volume of data to be stored and reduces the costs of the volatile memory.

According to a further embodiment, the non-volatile memory is additionally connected to the sensor.

This allows the data from the sensor following detection of the fault to be stored directly and permanently in the non-volatile memory, in other words without first being buffered in the volatile memory and then relocated.

In a further embodiment the device comprises at least two sensors. In this case the controller is configured, in the event of detection of a fault in one of the sensors by the monitoring unit, to analyze the temporal patterns of the permanently stored data from the sensors and to derive causes of the fault from the compared temporal patterns of the sensor data.

If in the event of a fault in one sensor, the data from at least two sensors are permanently stored, then the cause of the fault can be deduced. If the data from only one sensor, for example, after the detection of a fault in precisely this sensor, deviate from normal values for this sensor (=anomalous data) (for example, not being within a certain range defined by pre-specified limit values, or a sudden jump in otherwise constant values over time), but the stored data of the other sensors do not, then the existence of a faulty sensor can be assumed with greater confidence. However, if anomalous data exist for a plurality of the sensors from the time of detection of a fault, but which normalize again after a certain period of time, then a failure due to environmental influences (e.g. strong magnetic field or the like) can be assumed, especially as a simultaneous failure of more than one sensor is highly unlikely.

Therefore, a faulty sensor can be distinguished from a fault due to environmental influences with a high degree of certainty, and appropriate counter-measures can be introduced or normal operation can be resumed.

According to a further embodiment, at least two of the following elements are integrated in an integrated circuit or in a program:
controller;
monitoring unit;
volatile memory;
non-volatile memory.

By the integration of the monitoring unit and the controller in a common device a particularly fast data processing can be achieved, since there is no need to configure a data cable between two separate circuits or programs. The integration of the volatile and/or non-volatile memory can also accelerate the data transfer from the controller to the memory and/or between the memories.

Also described here are a computer program for carrying out the described method and a machine-readable storage medium on which this computer program is stored.

### BRIEF DESCRIPTION OF THE DRAWINGS

In the following, the device and the method are described in more detail by reference to the enclosed drawings. The exemplary embodiments shown are only intended to provide a better understanding and are not in any way to be interpreted restrictively. Shown are:

FIG. 1: a flow diagram of a described method for analyzing data from a sensor;

FIG. 2: a schematic representation of a described device for analyzing data from a sensor.

### DETAILED DESCRIPTION

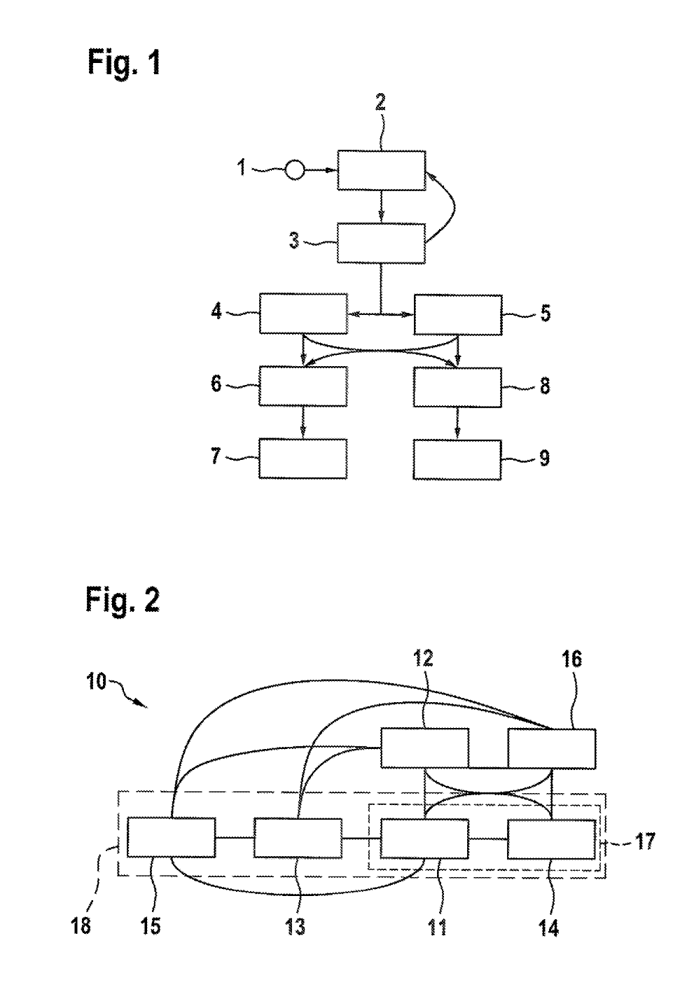

In the method shown in FIG. 1 as a flow diagram, after an initialization 1 a continuous storage 2 of data from a sensor, or at least two sensors, takes place. At the same time, a test is carried out for each data item whether a fault 3 is present in the sensor or sensors. As soon as a fault of the sensor or one of the sensors has been detected, a permanent storage 4 is carried out of the data from the sensor or sensors that were continuously stored before detection of the fault. Recording and permanent storage 5 of data from the sensor or sensors after detection of the fault also takes place, so that data are subsequently available that were generated before and after detection of the sensor fault. This is followed by an evaluation 6 of the permanently stored data of the sensor or sensors. Lastly, causes 7 for the fault are derived from the evaluated data from the sensor.

If data from at least two sensors have been permanently stored, then an analysis 8 can be performed on temporal patterns of the permanently stored data from the at least two sensors. This can be followed by a derivation of the natures of the fault 9.

The continuous storage 2 can be carried out cyclically, by in each case an oldest data item of the sensor or sensors being overwritten by a most recent data item of the sensor or sensors. As soon as a fault 3 has been detected in the sensor or one of the sensors on the basis of anomalous data from the sensor or sensors, the data of the sensor or sensors, which had been previously continuously stored, are secured by the permanent storage 4. The recording and permanent storage 5 can be carried out in such a way that either the data of the sensor or sensors following detection of the fault are written directly into the non-volatile memory or are first written to the volatile memory, and only then into the non-volatile memory. A number m of data records of the sensor or sensors before the detection of the fault and of n data records of the sensor or sensors after detection of the fault can be permanently stored.

The permanent storage of data generated before and after the detection of the fault means that there will be a large amount of information available, on the basis of which the derivation of causes 7 can be made with particular confidence. Also, if the data from at least two sensors have been permanently stored, the derivation of the causes of the fault 9 can be effected by comparing the temporal characteristics of the data of the different sensors in terms of anomalous data (outside of a pre-defined measuring range or jumps in the pattern). As a result, either the existence of interfering environmental influences or an actual fault in a sensor can be derived with great certainty.

FIG. 2 shows a schematic representation of a device 10 for analyzing data from a sensor or from at least two sensors. The device 10 comprises a controller 11 and a sensor 12, which is connected to the controller 11. The sensor 12 can be a position sensor or an accelerometer or an illumination sensor or a moisture sensor, or the like. The device 10 also comprises a volatile memory 13, which is connected to the controller 11 and the sensor 12. The volatile memory 13 is configured for continuously storing data of the sensor 12. The volatile memory 13 can be a Random Access Memory (RAM). The device 10 also comprises a monitoring unit 14, which is connected to the controller 11 and the sensor 12. The monitoring unit 14 is configured to detect faults in the sensor 12. The device 10 also comprises a non-volatile memory 15, which is connected to the controller 11 and the volatile memory 13. The non-volatile memory 15 can also be connected to the sensor 12. The non-volatile memory 15 is configured for permanently storing data from the volatile memory 13. The non-volatile memory 15 can be a secondary storage device, such as a hard disk, CD, DVD, floppy disk or a semiconductor memory (e.g. EPROM or Flash memory or the like). The controller 11 is configured, in the event of a detection of a fault in the sensor unit 12 by the monitoring unit 14, to relocate the data that has been stored before detection of the fault from the volatile memory 13 into the non-volatile memory 15. In addition, the controller 11 is configured to record data of the sensor 12 after detection of the fault and to store it permanently in the non-volatile memory. This can involve either storage in the volatile memory 13 followed by a relocation into the non-volatile memory 15, or a direct storage in the non-volatile memory 15. The controller 11 then evaluates the permanently stored data from the sensor 12 and derives causes of the fault from the evaluated data from the sensor 12.

The volatile memory 13 can be a first-in-first-out (FIFO) memory or ring buffer. In this process, the oldest data item from the sensor 12 is overwritten by the most recent data item from the sensor 12. A certain number of data items of the sensor 12 can thus be continuously and cyclically stored by the volatile memory 13.

The device 10 can also comprise a second sensor 16 and, if required, additional sensors (not shown). The second sensor 16, or the other sensors, are also connected to the controller 11, the volatile memory 13, the monitoring unit 14 and optionally to the non-volatile memory 15. The data of the second sensor 16 or the additional sensors are treated in the same way as the data from the sensor 12. Therefore, when a fault is detected by the monitoring unit 14, the data from the sensor 12 and the second sensor 16 or other sensors before and after detection of the fault can be stored permanently in the non-volatile memory 15. The controller 11 can compare the temporal patterns of the permanently stored data from the sensors and derive types of the fault from the temporal patterns of the compared data of the sensors, in particular with regard to anomalous data. This enables a genuine sensor fault to be distinguished from interfering environmental influences and appropriate counter-measures to be initiated, or a normal operating state to be restored.

The controller 11 and/or the volatile memory 13 and/or the monitoring unit 14 and/or the non-volatile memory 15 can be integrated in an integrated circuit, or in digital form in a program. The integrated circuit can be a microcontroller (PC) or an application-specific integrated circuit (ASIC) or an application-specific standard product (ASSP) or a field-programmable logic gate arrangement (FPGA), or similar. A corresponding program can be executed in a distributed fashion on one or a plurality of processors.

What is claimed is:

1. A method for operating a sensor, comprising:
continuously storing a first data of the sensor;
detecting of a fault of the sensor;
permanently storing the first data of the sensor continuously stored before the detection of the fault; and
recording and permanently storing a second data of the sensor after the detection of the fault.

2. The method according to claim 1, wherein the continuous storage of the first data of the sensor includes:
cyclically storing the first data of the sensor by overwriting an oldest data record of the sensor with a most recent data record of the sensor.

3. The method according to claim 1,
wherein the continuous storage of the first data of the sensor includes storing the first data from the sensor in a volatile memory until the detection of the fault, and
wherein the permanent storage of the first data from the sensor includes relocating the first data from the volatile memory into a non-volatile memory after detection of the fault.

4. The method according to claim 1,
wherein the first data from the sensor is stored during the permanent storage of the first data of the sensor continuously stored before the detection of the fault, or
wherein a predetermined number of data items of the sensor is stored during the permanent storage of the second data of the sensor after the detection of the fault.

5. The method according to claim 1, further comprising:
operating a device to analyze the first or second data from the sensor by (i) evaluating the permanently stored first or second data from the sensor; and (ii) deriving causes of the fault from the evaluated first or second data from the sensor.

6. The method according to claim 5, wherein:
the operation of the device further includes analyzing the first or second data from at least two sensors, and
during the detection of the fault of the sensor, if the fault is detected for at least one of the at least two sensors, then first or second data from the at least two sensors are permanently stored and recorded during (i) the permanent storage of the first data of the sensor continuously stored before the detection of the fault and (ii) the recording and the permanent storage of the second data of the sensor after the detection of the fault, and the operation of the device further includes:
analyzing temporal patterns of the permanently stored first or second data from the at least two sensors, and
deriving the causes of the fault of the at least one sensor for which the fault was detected.

7. A device for analyzing a first or a second data from a sensor, the device comprising:
a controller;
a connector for connecting the sensor to the controller;
a volatile memory configured to be connected to the controller and the sensor and further configured to continuously store the first and second data from the sensor;
the monitoring unit configured to be connected to the controller and the sensor or to the volatile memory and further configured to detect faults of the sensor; and
a non-volatile memory configured to be connected to the controller and the volatile memory and further configured for permanently storing the first and second data from the volatile memory,
wherein the controller is configured, upon detection of a fault of the sensor by a monitoring unit, to permanently store the first data of the sensor from the volatile memory before the detection of the fault into the non-volatile memory and to record the second data of the sensor after the detection of the fault and permanently store the second data in the non-volatile memory, and further configured to evaluate the permanently stored the first and second data of the sensor and to derive causes for the fault from the evaluated first and second data of the sensor, and
wherein the sensor is operated using a method, the method comprising:
continuously storing the first data of the sensor;
detecting of the fault of the sensor;
permanently storing the first data of the sensor continuously stored before the detection of the fault; and
recording and permanently storing the second data of the sensor after the detection of the fault.

8. The device according to claim 7, wherein the volatile memory is a first-in-first-out (FIFO) memory or ring buffer.

9. The device according to claim 7, wherein the non-volatile memory is further configured to connect to the sensor.

10. The device according to claim 7, wherein the device further comprised:
at least two sensors, and
wherein the controller, upon detection of a fault in one of the sensors by the monitoring unit, is further configured to analyze temporal patterns of the permanently stored first or second data of the sensors and to derive causes of the fault from compared patterns of the first and second data of the sensors.

11. The device according to claim 7, wherein at least two of the following elements are integrated in an integrated circuit or in a program: the controller, the monitoring unit, the volatile memory (13), and the non-volatile memory.

12. The method of claim 1, wherein a computer program is configured to execute all steps of the method for operating the sensor.

13. The computer program according to claim 12, wherein the computer program is stored on a computer-readable storage medium.
